(19) United States
(12) Patent Application Publication
(10) Pub. No.: US 2004/0118530 A1
(43) Pub. Date: Jun. 24, 2004

(54) Nonwoven products having a patterned indicia

(75) Inventors: Bernhardt E. Kressner, Appleton, WI (US); Timothy M. McFarland, Neenah, WI (US); Pamela M. Thompson, Neenah, WI (US); Wendy Jahner, Olatha, KS (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 10/325,469

(22) Filed: Dec. 19, 2002

(51) Int. Cl. B32B 27/12; B32B 5/02; D04H 1/56; D04H 3/16; B32B 5/26; D21H 27/30

(52) U.S. Cl. 162/109; 442/400; 442/401; 442/121; 442/123; 442/102; 428/196; 428/195.1; 442/381; 162/117; 424/402; 162/123

(57) ABSTRACT

A sheet-like product is disclosed having a patterned indicia for signifying the existence of an additive or ingredient that is contained within the product. The present inventors have discovered that a particular burst-like pattern provides various advantages and benefits in comparison to other patterns. In order to differentiate patterns of the present invention from other patterns, patterns made according to present invention were image analyzed during a dilation process.

### BACKGROUND OF THE INVENTION

Many wiping products, such as standard tissues, are normally white or of a uniform color. In some instances, such as for example, paper towels, decorative patterns may be printed on the outside of the product to enhance its appeal to the consumer. Nevertheless, tissues having additional special ingredients, such as lotions, virucides, encapsulated scents, and the like do not normally have a visually distinctive appearance that differentiates them from other products. Instead, they are typically white, colored or printed just like other wiping products and rely on their packaging to convey to the consumer that they have distinctive properties or characteristics.

In order to make tissues containing special ingredients visually distinguishable from other tissues, a multi-ply tissue having internal indicia is disclosed in U.S. Pat. No. 6,221,211 to Hollenberg et al., which is incorporated herein by reference. In Hollenberg et al., a visual indicator which indicates that the product contains unique ingredients or properties is printed, dyed, or otherwise applied to an internal surface of one or more plies in a multi-ply tissue. The visual indicator can be in the form of decorative patterns such as floral patterns, caricatures, and the like or geometric and abstract patterns, such as repeating dots, squares, rhomboids, triangles and the like.

Although Hollenberg et al. has provided great advancements in the art, the present invention is directed to further improvements. In particular, although the use of printed indicia to indicate that a tissue product contains unique ingredients is effective for its purpose, the present inventors have realized that printing relatively large amounts of ink onto a product can adversely interfere with the overall aesthetics of the product. Specifically, some users of a tissue product can perceive ink as a contaminant and therefore less desirable. Inks may also increase the stiffness of base sheets and can create odor issues.

As such, a need currently exists for a patterned indicia that can be applied to nonwoven products that is effective in indicating the presence of a particular additive without adversely interfering with the overall aesthetics of the product.

### Definition

As used herein, percent area coverage of a pattern versus dilation is to be determined using a QUANTIMET image-analysis system commercially marketed by Leica, Inc. of Bannockburn, Ill., such as the QUANTIMET 970 image analysis system or any similar like system. Such systems are capable of analyzing patterns by dilating (or “growing”) an already formed pattern and plotting the resulting percent surface area coverage. The resulting plot can then be fitted to a second-order polynomal which provides a means of distinguishing one pattern from another. The operation of a QUANTIMET image-analysis system is further described in the example below.

### SUMMARY OF THE INVENTION

The present invention is generally directed to nonwoven products, such as nonwoven materials containing pulp fibers, and/or synthetic polymeric fibers, that are provided with a distinctive visual cue or patterned indicia which indicates that the product contains a particular additive, such as a chemical ingredient. The present inventors have discovered that a particular pattern provides benefits and advantages in comparison to various other patterns. The pattern of the present invention includes a burst-like design or pattern that conveys to a user that the product contains a particular additive and differentiates the product from other competitor products. The pattern of the present invention has been found to be well suited for indicating the presence of an additive in a nonwoven product while at the same time using a minimal amount of ink or dye in constructing the pattern.

In one embodiment, for instance, the present invention is directed to a nonwoven product that comprises a base sheet. The base sheet can contain one or more plies of a nonwoven web. According to the present invention, the base sheet includes a patterned indicia indicating the presence of an additive that has been applied to the base sheet. The patterned indicia is visible from at least one side of the base sheet. The patterned indicia has a burst-like design that, when comparing percent area coverage of the indicia versus dilation, the patterned indicia is defined by the following mathematical expression:

f(x)=Ax²+Bx+Y

wherein A is from about −0.7 to about −0.4; B is from about 12 to about 16; and Y is from about 2 to about 5.

The patterned indicia of the present invention can be used to indicate the presence of any suitable additive. Examples of additives include, for instance, virucides, softeners such a polysiloxanes, emollients, antiseptic agents, encapsulated scents, cleansing agents, moisturizers, antimicrobial agents, and the like.

In one embodiment, the nonwoven product can contain multiple plies. The patterned indicia can be printed, dyed, or otherwise applied to an internal surface of one or more of the plies. The patterned indicia can be applied such that the indicia is visible through the outer plies of the product. The visibility of the internally applied patterned indicia can be controlled by the basis weight of the outer plies and/or the intensity of the coloration.

It should be understood, that in other embodiments, the patterned indicia can also be located on the outside surfaces of the base sheet.

The nonwoven product treated in accordance with the present invention can be, for instance, a tissue product made with pulp fibers. The tissue product can be, for instance, a bath tissue, a facial tissue, a paper towel, and the like. The tissue product can have a basis weight of from about 10 gsm to about 100 gsm.

The nonwoven product of the present invention can also be a pre-moistened wipe, including wet wipes and pre-moistened bath tissue. Other products treated in accordance with the present invention include disposable products made from polymeric fibers, such as products containing meltblown webs, spunbond webs, and laminates thereof.

The color of the patterned indicia can be any suitable color, such as green, peach, white, or pink. In one particular embodiment, for instance, the non-woven product has a white color, while the patterned indicia is light blue.

### BRIEF DESCRIPTION OF THE DRAWINGS

A full and enabling disclosure of the present invention, including the best mode thereof to one of ordinary skill in the art, is set forth more particularly in the remainder of the specification, including reference to the accompanying figures in which:

FIG. 1 is a plan view of one embodiment of a patterned indicia to be used in accordance with the present invention;

FIG. 2 is a cross sectional view of one embodiment of a nonwoven product treated in accordance with the present invention;

FIG. 3 is a cross sectional view of another embodiment of a nonwoven product treated in accordance with the present invention;

FIG. 4 is a plan view of another embodiment of a patterned indicia for use in the present invention;

FIG. 5 is a plan view of still another embodiment of a patterned indicia for use in the present invention;

FIG. 6 is a plan view of another embodiment of a patterned indicia for use in the present invention;

FIGS. 7 through 21 are plan views of different patterns used in the Example below to compare with the patterns of the present invention; and

FIG. 22 is a graphical representation of the results obtained in the Example when percent area was plotted versus dilation step using the QUANTIMET 970 image analysis system for the patterned indicia illustrated in FIG. 1 that has been rotated 20 degrees.

Repeated use of reference characteristics in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

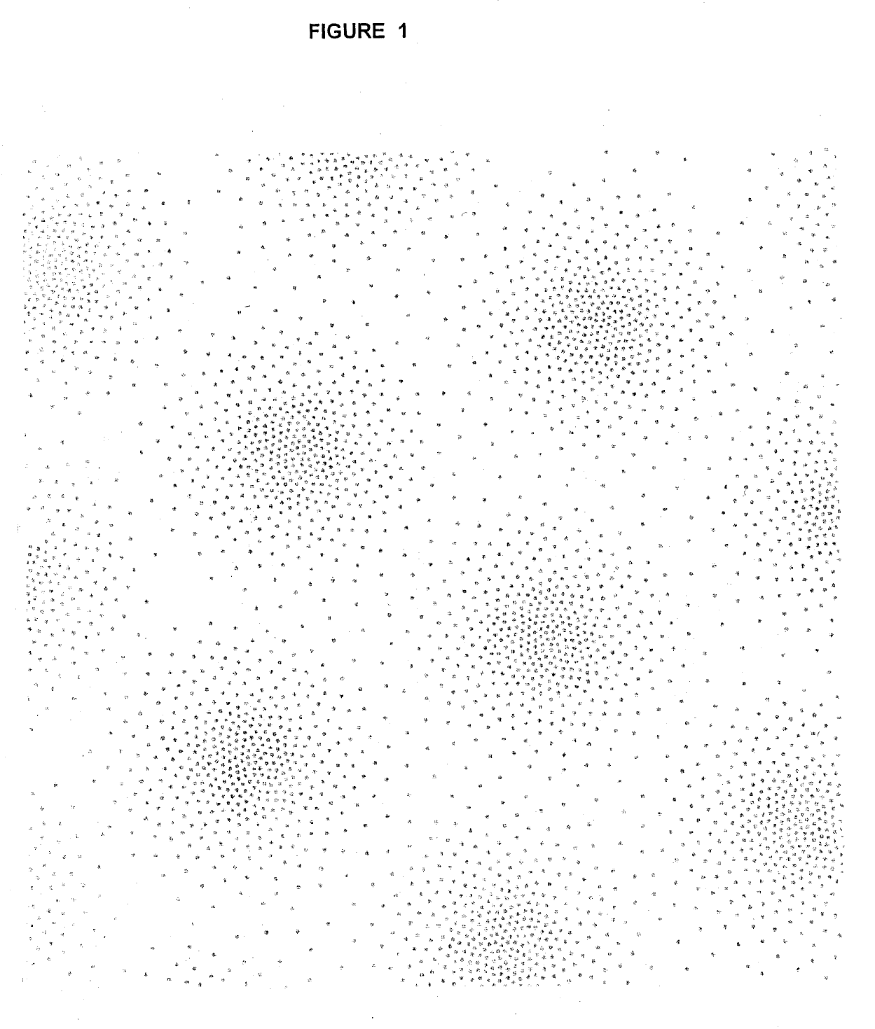

In general, the present invention is directed to sheet-like products that contain a patterned indicia that indicates the presence of an additive, such as a chemical additive, that has been applied to the product. Referring to FIG. 1, for instance, one embodiment of the patterned indicia of the present invention is shown. As illustrated, the patterned indicia of the present invention generally has a repeating burst-like design. Through focus groups and different studies, the present inventors have discovered that the burst-like pattern as shown in FIG. 1 provides various advantages and benefits over other various patterns.

The patterned indicia is intended to signify the presence of a particular additive or special ingredient and to distinguish the product from other competing products. It is believe that visual cues are more effective for this purpose than other cues, such as an olfactory cue. With respect to the burst-like pattern as shown in FIG. 1, this particular pattern as opposed to other patterns has been found to convey the impression to a consumer that the product does in fact contain a desired additive and that the additive is somehow randomly applied to the product which was found to be appealing. Further, the pattern signifies the presence of the additive while using a minimal amount of ink or dye. When present in, for instance, a tissue product, inks and dyes may have an unappealing effect to consumers as they made view the ink or dye as a contaminate. This adverse effect, however, has been found to be minimized by the burst-like pattern as shown in FIG. 1. Further, by using minimal amounts of ink, the properties of the product, such as stiffness and odor, are not adversely affected.

Overall, the present inventors have discovered that the burst-like pattern is well-suited to differentiating a treated tissue from other products. Further, the burst-like pattern communicates to the consumer that the product contains a beneficial additive without adversely interfering with the overall aesthetics of the product.

In order to characterize the burst-like pattern of the present invention, the pattern has been image analyzed as will be described in more detail in the following Example. Specifically, when comparing percent area coverage of the patterned indicia versus dilation, the patterned indicia of the present invention may be defined by the following mathematical expression:

f(x)=Ax²+Bx+Y

wherein A is from about −0.7 to about −0.4; B is from about 12 to about 16; and Y is from about 2 to about 5. The above mathematical equation is believed to characterize or “fingerprint” the patterned indicia of the present invention and may be used to differentiate the pattern from other patterns not falling within the scope of the present invention.

The patterned indicia of the present invention can be applied to any sheet-like product by any suitable technique. For instance, the patterned indicia can be applied to a product by printing, spraying, beater dyeing fibers, coating, and the like.

The patterned indicia can be applied to single ply or multi ply products. In one embodiment, for instance, the patterned indicia can be applied to one or both outside services of a product. Alternatively, when the product contains multiple plies, the patterned indicia can be applied to an internal surface as long as the patterned indicia is visible from at least one side of the product.

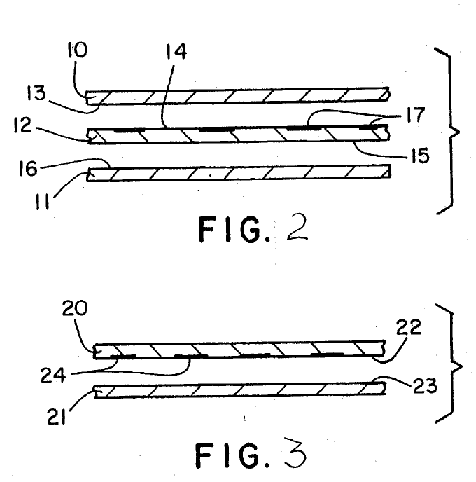

For example, FIG. 2 is a schematic cross-sectional view of a 3-ply sheet-like product made in accordance with the present invention. Shown as a first outer ply 10, a second outer ply 11, and a single inner ply 12. The product includes internal ply surfaces 13, 14, 15 and 16. In accordance with the present invention, the burst-like patterned indicia 17, in this embodiment, has been applied to the internal ply surface 14. By controlling the basis weight and opacity of the outer ply 10, and the intensity of the coloration of the patterned indicia 17, the patterned indicia can remain visible through the ply 10 for indicating the presence of an additive.

In addition to or instead of applying the patterned indicia 17 to the internal surface 14, it should also be understood that the patterned indicia can also be applied to internal surfaces 13, 15 and 16.

Referring to FIG. 3, a schematic cross-sectional view of an embodiment of a 2-ply product made in accordance with the present invention is shown. In this embodiment, the product includes outer plies 20 and 21 and internal ply surfaces 22 and 23. A patterned indicia 24 made in accordance with the present invention is shown applied to the internal surface 22. In this manner, the patterned indicia can be visible from the product through one outside surface or through both of the outside surfaces.

The color and shade of the patterned indicia of the present invention can vary depending upon the particular application. In general, any suitable color can be used as long as the patterned indicia is visible to the user of the product. When the sheet-like product is white in color, for instance, the patterned indicia can be green, peach, blue, pink, and the like. In one particular embodiment, for example, the patterned indicia has a light blue color. The present inventors have discovered that a light blue color, in some applications, is perceived by consumers as safe, sterile and clean. Other colors and shades, however, may have particular benefits in various applications.

The patterned indicia of the present invention can be used to signify the presence of any particular chemical additive or special ingredient contained within the sheet-like product. For example, in one embodiment, the patterned indicia can be used to indicate the presence of a virucide. For example, suitable virucidal compositions include but are not limited to those disclosed in U.S. Pat. No. 4,738,847 to Rothe et al. Such compositions include, but are not limited to, acids having the formula R—COOH, where R is selected from the group consisting of lower alkyl; substituted lower alkyl; carboxy lower alkyl; carboxy hydroxy lower alkyl; carboxy halo lower alkyl; carboxy dye hydroxy lower alkyl; die carboxy hydroxy lower alkyl; lower alkenyl; carboxy lower alkenyl; dye carboxy lower alkenyl; and phenyl and substituted phenyl groups. Also included are surfactants and/or combinations of acids and surfactants, such as combinations of acids and anionic surfactants. Exemplary virucidal compositions include citric acid, malic acid, mixtures of citric acid and malic acid, and combinations of these acids with sodium lauryl sulfate. It should be understood, however, that many other virucidal compositions may also be used in conjunction with the patterned indicia.

In another embodiment, the patterned indicia can be used to signify the presence of a softener, such as a polysiloxane. Suitable polysiloxanes include, without limitation, polydimethyl siloxanes; mixtures of polydimethyl siloxanes; and alkylene oxide-modified polydimethyl siloxanes; organomodified polysiloxanes; mixtures of cylic- and non cyclic-modified dimethyl siloxanes; and the like. Amino-modified polysiloxanes can also be used.

In addition to virucides and softeners, the patterned indicia of the present invention can also be used to signify the presence of, for instance, emollients, encapsulated scents such as menthol, eucalyptus, bayberry, potpourri, and the like, cleansing agents, moisturizers, antimicrobial agents, antiseptic agents, and any other suitable ingredient.

The additive can be applied to the sheet-like product independently of the patterned indicia. For example, a virucide can be sprayed or printed over the entire surface of a sheet-like product, while the patterned indicia can be a printed ink or dye pattern. Alternatively, the additive can be incorporated into the patterned indicia so that the indicia marks the portions of the product that contain the additive. Either way, the patterned indicia indicates the presence of the additive in the product.

In general, any suitable sheet-like product may be treated with the patterned indicia in accordance with the present invention for indicating the presence of an additive. For example, in one embodiment, the sheet-like product can be a tissue product, such as a bath tissue, a facial tissue, a paper towel, an industrial wiper, and the like. Tissue products typically have a bulk density of at least 2 cc/g. The tissue products can contain one or more plies and can be made from many suitable types of fiber.

Fibers suitable for making paperwebs comprise any natural or synthetic cellulosic fibers including, but not limited to nonwoody fibers, such as cotton, abaca, kenaf, sabai grass, flax, esparto grass, straw, jute hemp, bagasse, milkweed floss fibers, and pineapple leaf fibers; and woody fibers such as those obtained from deciduous and coniferous trees, including softwood fibers, such as northern and southern softwood kraft fibers; hardwood fibers, such as eucalyptus, maple, birch, and aspen. Woody fibers can be prepared in high-yield or low-yield forms and can be pulped in any known method, including kraft, sulfite, high-yield pulping methods and other known pulping methods. Fibers prepared from organosolv pulping methods can also be used, including the fibers and methods disclosed in U.S. Pat. No. 4,793,898, issued Dec. 27, 1988 to Laamanen et al.; U.S. Pat. No. 4,594,130, issued Jun. 10, 1986 to Chang et al.; and U.S. Pat. No. 3,585,104. Useful fibers can also be produced by anthraquinone pulping, exemplified by U.S. Pat. No. 5,595,628, issued Jan. 21, 1997 to Gordon et al. A portion of the fibers, such as up to 50% or less by dry weight, or from about 5% to about 30% by dry weight, can be synthetic fibers such as rayon, polyolefin fibers, polyester fibers, bicomponent sheath-core fibers, multi-component binder fibers, and the like. An exemplary polyethylene fiber is Pulpex®, available from Hercules, Inc. (Wilmington, Del.). Any known bleaching method can be used. Synthetic cellulose fiber types include rayon in all its varieties and other fibers derived from viscose or chemically modified cellulose. Chemically treated natural cellulosic fibers can be used such as mercerized pulps, chemically stiffened or crosslinked fibers, or sulfonated fibers. For good mechanical properties in using papermaking fibers, it can be desirable that the fibers be relatively undamaged and largely unrefined or only lightly refined. While recycled fibers can be used, virgin fibers are generally useful for their mechanical properties and lack of contaminants. Mercerized fibers, regenerated cellulosic fibers, cellulose produced by microbes, rayon, and other cellulosic material or cellulosic derivatives can be used. Suitable papermaking fibers can also include recycled fibers, virgin fibers, or mixes thereof. In certain embodiments capable of high bulk and good compressive properties, the fibers can have a Canadian Standard Freeness of at least 200, more specifically at least 300, more specifically still at least 400, and most specifically at least 500.

Other papermaking fibers that can be used in the present invention include paper broke or recycled fibers and high yield fibers. High yield pulp fibers are those papermaking fibers produced by pulping processes providing a yield of about 65% or greater, more specifically about 75% or greater, and still more specifically about 75% to about 95%. Yield is the resulting amount of processed fibers expressed as a percentage of the initial wood mass. Such pulping processes include bleached chemithermomechanical pulp (BCTMP), chemithermomechanical pulp (CTMP), pressure/pressure thermomechanical pulp (PTMP), thermomechanical pulp (TMP), thermomechanical chemical pulp (TMCP), high yield sulfite pulps, and high yield Kraft pulps, all of which leave the resulting fibers with high levels of lignin. High yield fibers are well known for their stiffness in both dry and wet states relative to typical chemically pulped fibers. In general, any process capable of forming a paperweb can also be utilized in the present invention. For example, a papermaking process of the present invention can utilize creping, wet creping, double creping, embossing, wet pressing, air pressing, through-air drying, creped through-air drying, uncreped through-air drying, as well as other steps known in the art.

The basis weight of paper webs used in the present invention can vary depending upon the particular application. In general, for most applications, the basis weight can be from about 6 gsm to about 140 gsm, and particularly from about 10 gsm to about 80 gsm. For example, bath tissues and facial tissues typically have a basis weight of less than about 40 gsm. Paper towels, on the other hand, typically have a basis weight of greater than about 30 gsm.

In addition to dry wiping products, the patterned indicia of the present invention can also be applied to pre-moistened wiping products or wet wipes which can include pre-moistened bath tissue.

The wet wipes may comprise a single layer or a layered base sheet that contains a liquid. The liquid is typically any solution which can be absorbed into the wet wipe base sheet and may include any suitable components which provide the desired wiping properties. Typically, the components include water, emollients, surfactants, fragrances, preservatives, chelating agents, pH buffers or combinations thereof as are well known to those skilled in the art. The liquid may also contain certain lotions and/or medicaments. The emulsion composition is designed to provide improved skin health benefits, such as enhanced barrier function and protection of the skin.

The amount of the oil-in-water emulsion composition contained within each wet wipe may vary depending upon the type of material being used to provide the wet wipe or wipe-type product, the type of container being used to store the wet wipes, and the desired end use of the wet wipe. Generally, each wet wipe or wipe-type product can contain from about 100 to about 600 weight percent and desirably from about 250 to about 450 weight percent liquid based on the dry weight of the wipe for improved wiping.

Each wet wipe is generally rectangular in shape and may have any suitable unfolded width and length. Typically, each individual wet wipe is arranged in a folded configuration and stacked one on top of the other to provide a stack of wet wipes. Such folded configurations are well known to those skilled in the art and include c-folded, z-folded, quarter-folded configurations and the like. The stack of folded wet wipes may be placed in the interior of a container, such as a plastic tub, to provide a package of wet wipes for eventual sale to the consumer. Alternatively, the wet wipes may include a continuous strip of material which has perforations between each wipe and which may be arranged in a stack or wound into a roll for dispensing.

The materials of the base sheet, single or multi-layered, of the wet wipe or the wipe-type product of the present invention may be varied to provide different physical properties. The different physical properties which a layer may be configured to provide by selecting the appropriate materials include softness, resiliency, strength, flexibility, integrity, toughness, absorbency, liquid retention, thickness, tear resistance, surface texture, drapability, hand, wettability, wicking ability and the like and combinations thereof. The wipe can be configured to provide all desired physical properties within one layer or configured to provide only specific physical properties within individual layers of a multi-layered wipe. For example, the wet wipes may include at least one layer of material that is configured to provide strength and resilience to the wet wipe and at least one other layer which is configured to provide a soft, gentle wiping surface to the wet wipe. Desirably, the wet wipes provide a soft wiping surface for contact with the skin.

The layer or layers of the wet wipe or wipe-type products can be made from a variety of materials including meltblown materials, coform materials, air-laid materials, bonded-carded web materials, hydroentangled materials, spunbond materials and the like and can comprise synthetic or natural fibers. Examples of natural fibers suitable for use in the present invention include cellulosic fibers such as wood pulp fibers, cotton fibers, flax fibers, jute fibers, silk fibers and the like. Examples of thermoplastic polymeric fibers suitable for use with the present invention include polyolefins such as polypropylene and polyethylene, polyamides, and polyesters such as polyethylene terephthalate. Alternative synthetic fibers which may be suitable include staple nylon and rayon fibers. The layer or layers of the wet wipe or wipe-type products can be woven or nonwoven materials.

If a layer of the base sheet is a combination of polymeric and natural fibers, such as polypropylene and cellulosic fibers, the relative percentages of the polymeric fibers and natural fibers in the layer can vary over a wide range depending on the desired characteristics of the wet wipes. For example, the layer may comprise from about 20 to about 95 weight percent, desirably from about 20 to about 60 weight percent, and more desirably from about 30 to about 40 weight percent of polymeric fibers based on the dry weight of the layer. Such a layer of polymeric and natural fibers may be manufactured by any method known to those skilled in the art.

Generally, it is desirable that such a layer be formed by a coform process for a more uniform distribution of the polymeric and natural fibers within the layer. Such coform layers are manufactured generally as described in U.S. Pat. No. 4,100,324 to Anderson et al. which issued Jul. 11, 1978; U.S. Pat. No. 4,604,313 to McFarland et al. which issued Aug. 5, 1986; and U.S. Pat. No. 5,350,624 which issued Sep. 27, 1994; which are herein incorporated by reference to the extent they are consistent herewith.

Typically, such coform layers comprise a gas-formed matrix of thermoplastic polymeric meltblown microfibers, such as, for example, polypropylene microfibers, and cellulosic fibers, such as, for example, wood pulp fibers. A coform layer is formed by initially forming at least one primary air stream containing the synthetic or polymeric fibers and merging the primary stream with at least one secondary stream of natural or cellulosic fibers. The primary and secondary streams are merged under turbulent conditions to form an integrated stream containing a thorough, homogeneous distribution of the different fibers. The integrated air stream is directed onto a forming surface to air form the layer of material. A multiplicity of these coform layers can then be formed in succession to provide a web of multiple coform layers.

The base sheet for the wet wipes or wipe-type products may have a total basis weight of from about 10 to about 120 grams per square meter, such as from about 40 to about 90 grams per square meter. The basis weight of the layered base sheet may vary depending upon the desired end use of the wet wipe or wipe-type products.

In addition to tissue products and wet wipes, the patterned indicia of the present invention can also be applied to polymeric films, nonwoven webs made from synthetic polymeric fibers, and laminates containing the films and nonwoven webs. Such materials can be used in forming absorbent wipers, towels, industrial garments, medical garments, medical drapes, and the like. The above materials are also well suited for use in the manufacture of personal care articles, such as diapers, feminine hygiene products, and the like.

The nonwoven webs identified above particularly refer to webs made on the spunbond and meltblown processes. For instance, spunbond webs are typically produced by heating a thermoplastic polymeric resin to at least its softening temperature. The polymeric resin is then extruded through a spinnerette to form continuous fibers, which can then be subsequently fed through a fiber draw unit. From the fiber draw unit, the fibers are spread onto a foraminous surface where they are formed into a web and then bonded such as by mechanical, thermal, or ultrasonic means.

Meltblown fabrics, on the other hand, have been conventionally made by extruding a thermoplastic polymeric material through a die to form fibers. As the molten polymer filaments exit the die, high pressure fluid, such as heated air or steam attenuates the molten polymer filaments to form fine fibers. Surrounding cool air is induced into the hot air stream which cools and solidifies the fibers. The fibers are then randomly deposited onto a foraminous surface to form a web. The web has integrity as made but may be additionally bonded.

The above nonwoven webs can generally have a basis weight of from about 20 gsm to about 200 gsm. The nonwoven webs may be used to construct various laminates. For example, spunbond-meltblown-spunbond laminates have many diverse applications. Such multi-layer laminates may be formed by a number of different techniques including but not limited to using adhesives, needle punching, ultrasonic bonding, thermal calendering and any other method known in the art.

The patterned indicia of the present invention may be applied to any of the above described products to indicate the presence of an additive in the product.

The present invention may be better understood with respect to the following example.

### EXAMPLE

The following example was performed in order to characterize the burst-like pattern of the present invention in comparison to other patterns.

Specifically, various patterns were dilated or “grown” and a plot was created of the resulting surface area percent coverage versus dilation step. After the results were obtained, a second-order polynomial was determined from the plot. The second-order polynomial characterized the pattern that was analyzed and provided a point of comparison between different patterns.

In order to conduct the image analysis of the patterns, a QUANTIMET 970 image analysis system was used which was obtained from Leica, Inc. of Bannockburn, Ill. The QUANTIMET 970 image analysis system was equipped with a CHALNICON camera and a 20 mm Nikon lens, f2.8, which was obtained from the Nikon OEM sales group of New York, N.Y. The camera was mounted on a KREONITE macroviewer manufactured by the KREONITE Company of St. Louis, Mo. The KREONITE macroviewer was equipped with four incident flood lamps. The camera was placed at the 75 cm pole position on the macroviewer above a 6 inch high auto stage used as a spacer.

Samples of the patterns tested were placed under glass below the camera. The total field-of-view was 210 mm×168 mm with a live frame of 93 mm×110 mm.

The following routine was programmed into the image analysis system.

ROUTINE

```
DOES = % A VS DILATION AND TESSELATION HISTOGRAMS
COND = 20 MM NIKON. F/2.8: VNDF: 4 FLOODS: AUTOSTGE AS SPACER:
  GLASS 75-CM POLE POSITION: WHITE BCKGRND UNDER SAMPLES
Enter specimen identity
Scanner ( No. 2 Chalnicon LV= 0.00 SENS = 2.07 )
SUBRTN STANDARD
Load Shading Corrector ( pattern - BURST )
Calibrate User Specified (Cal Value = 0.2332 millimetres per pixel)
Scanner  ( No. 2 Chalnicon AUTO-SENSITIVITY LV= 0.00 )
Image Frame is Rectangle ( X: 223. Y: 153. W: 405. H: 475. )
Live frame is Rectangle ( X: 225. Y: 155. W: 400. H: 470. )
Detect 20 ( Darker than 56. Delin PAUSE )
For LOOPCOUNT = 0 to 15
Measure field - Parameters into array FIELD
PERCAREA := 100. * FIELD AREAFRACT
Distribute PERCAREA (Units % AREA ) vs LOOPCOUNT
  into GRAPH from  0.00 to  15.00 into 15 bins. differential
Measure feature  AREA  X.FCP  Y.FCP
into array FEATURE ( of 1000 features and 5 parameters )
FEATURE CALC := ( ( 4. * area/PI )\hat{ }0.50000 )
Distribution of COUNT v CALC (Units MM
  from FEATURE in HIST02 FROM 1.000 TO 100.0
  in 25 bins (log)
Amend  ( DILATE by 1 - Horizontally )
Amend  ( DILATE by 1 - Vertically )
Next
Scanner  ( No. 2 Chalnicon AUTO-SENSITIVITY LV= 0.00 )
Issue Frame is Rectangle (X: 222, Y: 155, W: 471. H: 506. )
Live Frame is Rectangle ( X: 180. Y: 135. W: 538. H: 551. )
Detect 20 ( Darker than 55. Delin )
Amend (INVERSE SKELETON - by 150 )
Measure feature  AREA  X.FCP  Y.FCP
  Into array FEATURE ( of 1000 features and  5 parameters )
FEATURE CALC := ( ( 4. * area/PI ) \hat{ } 0.50000 )
Distribution of COUNT v CALC (Units MM )
  from FEATURE in HISTO1 from 1.000 TO 100.0
  in 25 bins (LOG))
Print “ ”
```

| | |
|---|---|
| Print Distribution ( GRAPH. differential. bar chart. scale = | 0.00 ) |
| Print “ ” | |
| Print “ ” | |
| Print Distribution ( HIST01. differential. bar chart. scale = | 0.00 ) |
| Print “CT VS ECD VS INV SKELETTON” | |
| For LOOPCOUNT = 1 TO 15 | |
| Print “ ” | |
| Next | |
| Print “ ” | |
| Print Distribution ( HIST02. differential. bar chart. scale = | 0.00 ) |
| Print “COUNT VS ECD VS DILATION” | |
| For LOOPCOUNT = 1 TO 15 | |
| Print “ ” | |
| Next | |
| END OF PROGRAM | |

Once a pattern was viewed by the system, the QUANTIMET 970 image analysis system caused the pattern to grow in the X and Y directions pixel by pixel. As the pattern was dilated, the percent surface area covered was recorded at particular dilation steps. Also, an initial reading was taken which accounted for the amount of surface area the pattern occupied prior to any dilation. The following is the dilation step size starting with a 2 pixel “seed” or core.

DILATION STEP SIZE

| AMEND AMT | ECD. MM | AREA. SQ. MM |
|---|---|---|
| 0. | 0.52627 | 0.21752 |
| 1. | 1.116 | 0.97885 |
| 2. | 1.664 | 2.175 |
| 3. | 2.202 | 3.807 |
| 4. | 2.735 | 5.873 |
| 5. | 3.265 | 8.375 |
| 6. | 3.795 | 11.311 |
| 7. | 4.324 | 14.683 |
| 8. | 4.852 | 18.489 |
| 9. | 5.380 | 22.731 |
| 10. | 5.907 | 27.408 |
| 11. | 6.435 | 32.520 |
| 12. | 6.962 | 38.066 |
| 13. | 7.489 | 44.048 |
| 14. | 8.016 | 50.465 |
| 15. | 8.543 | 57.317 |

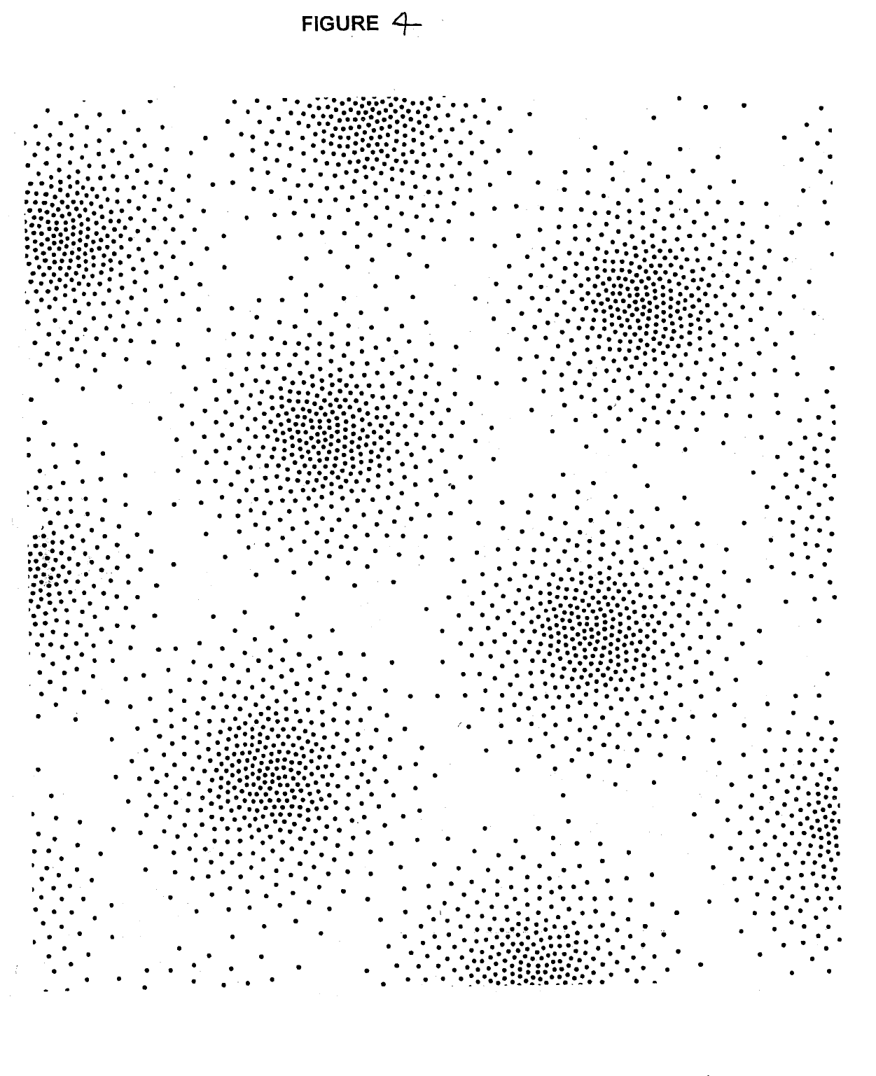

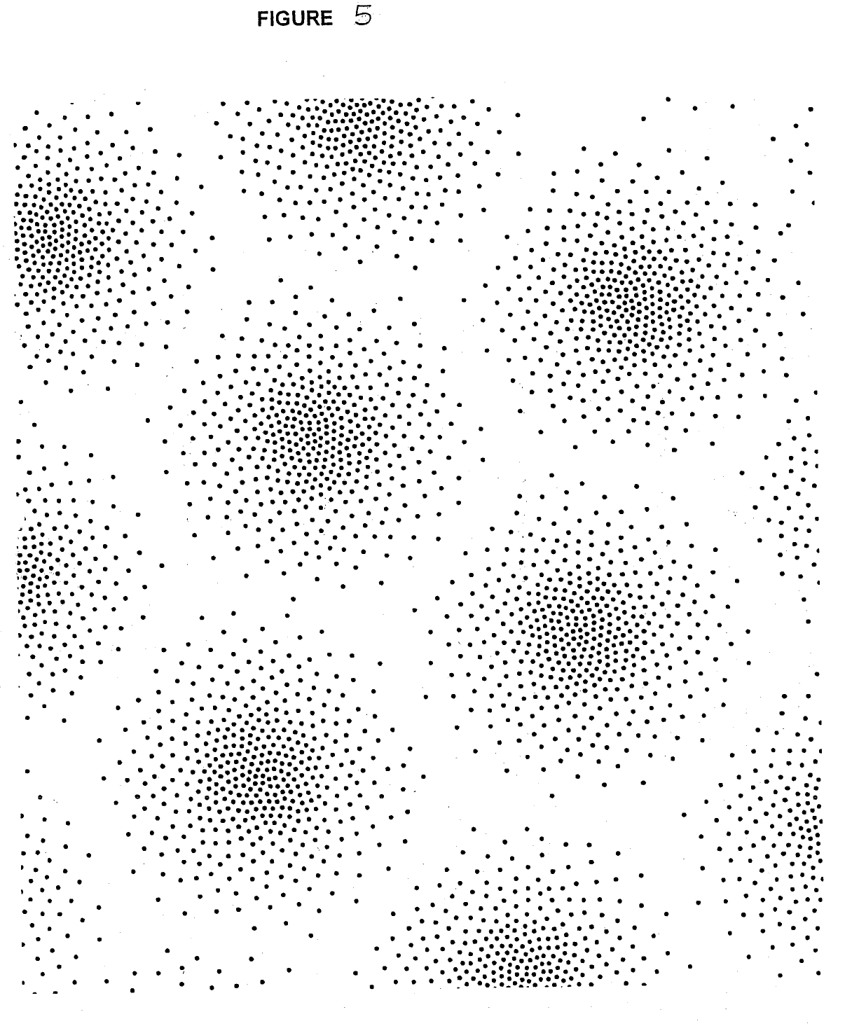

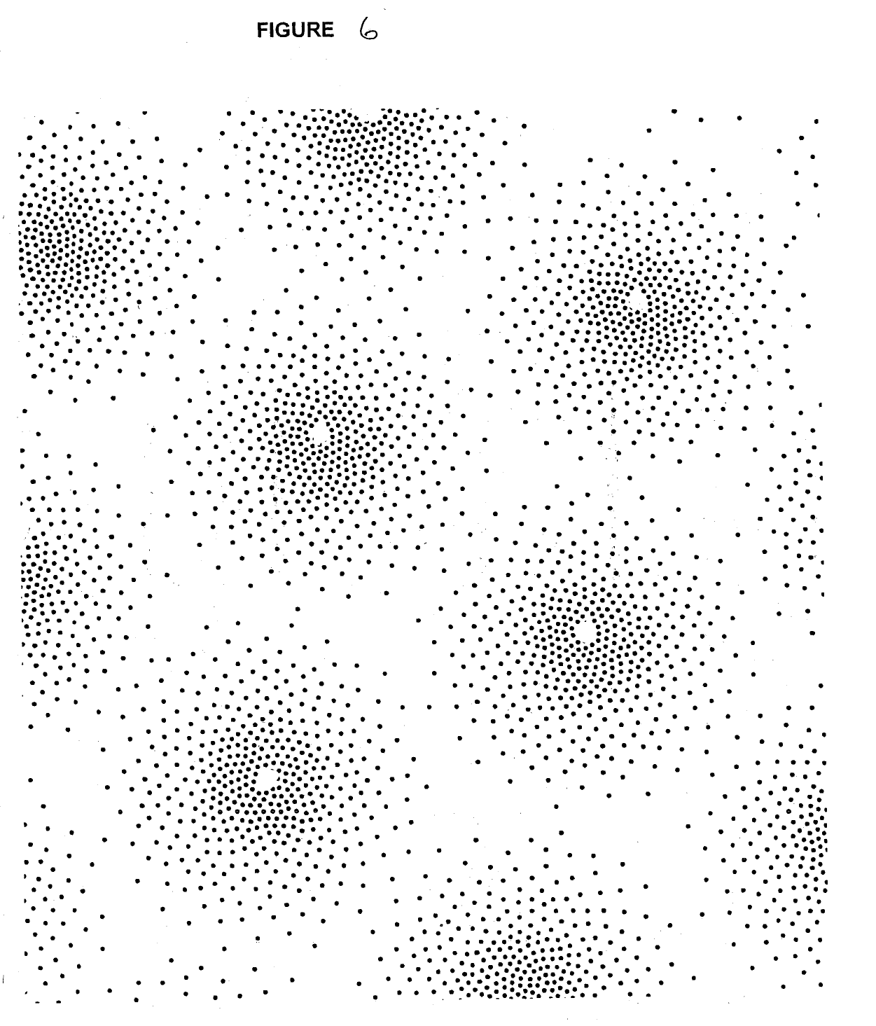

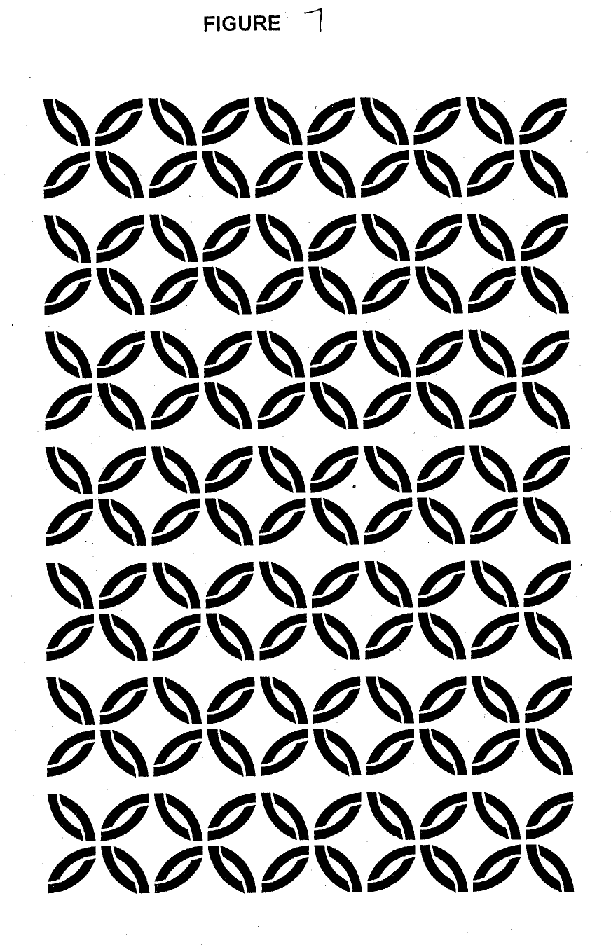

The patterns that were analyzed in this example are shown in the figures. Specifically, the burst-like pattern illustrated in FIG. 1 was analyzed, rotated 20 degrees and analyzed again, and rotated 40 degrees and analyzed again. Other burst-like patterns made according to the present invention that were analyzed include the patterns shown in FIGS. 4, 5 and 6. FIG. 5 is similar to FIG. 4 except the dots that transition from one burst-like design to the next were removed. The pattern shown in FIG. 6 is also similar to the pattern shown in FIG. 4 except the dots appearing in the center of each of the burst-like designs were removed.

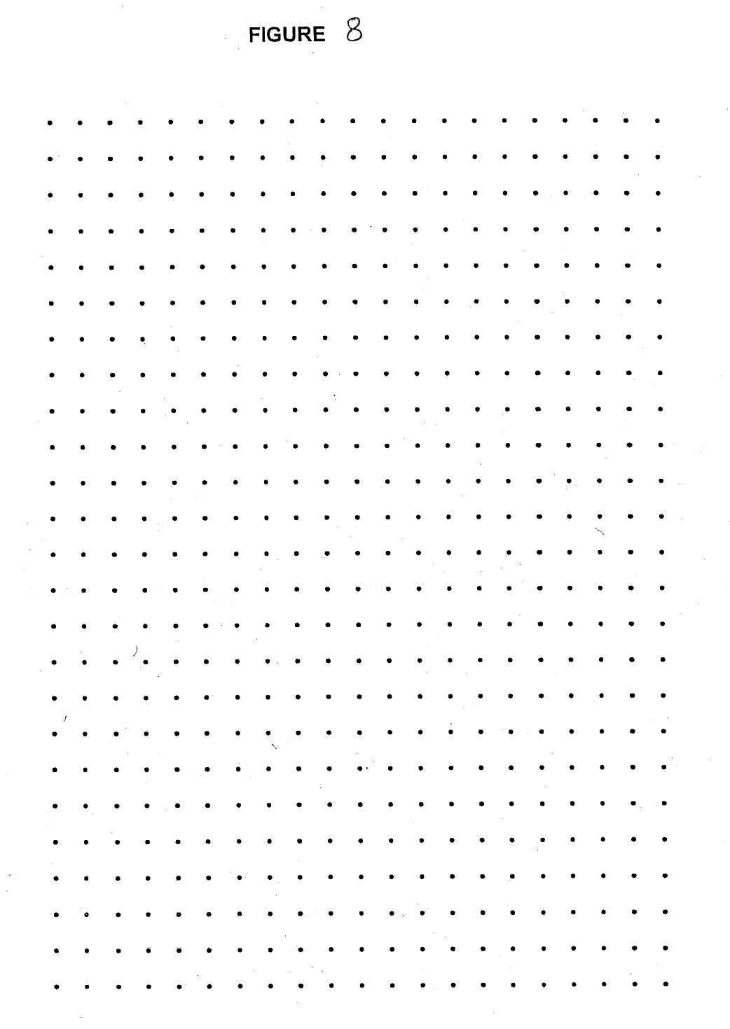

For comparative purposes, the patterns illustrated in FIGS. 7 through 21 were also analyzed.

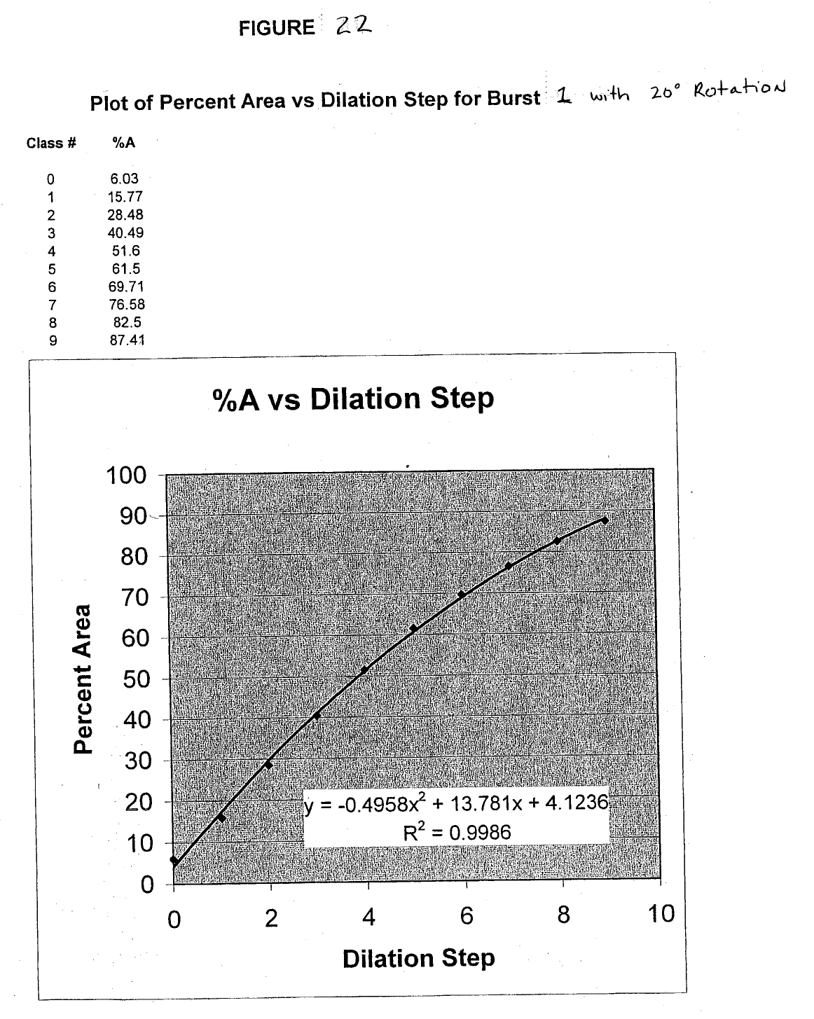

As described above, once a pattern was analyzed, a graph was obtained that compared percent surface area coverage versus dilation step. For example, referring to FIG. 22, the plot of percent surface area coverage versus dilation step for the burst-like pattern illustrated in FIG. 1 is shown after the pattern had been rotated 20 degrees. As shown in FIG. 22 from the plot, a second-order polynomial was derived. The y-intercept of the polynomial represents the initial surface area coverage of the pattern.

The following results were obtained for the patterns tested.

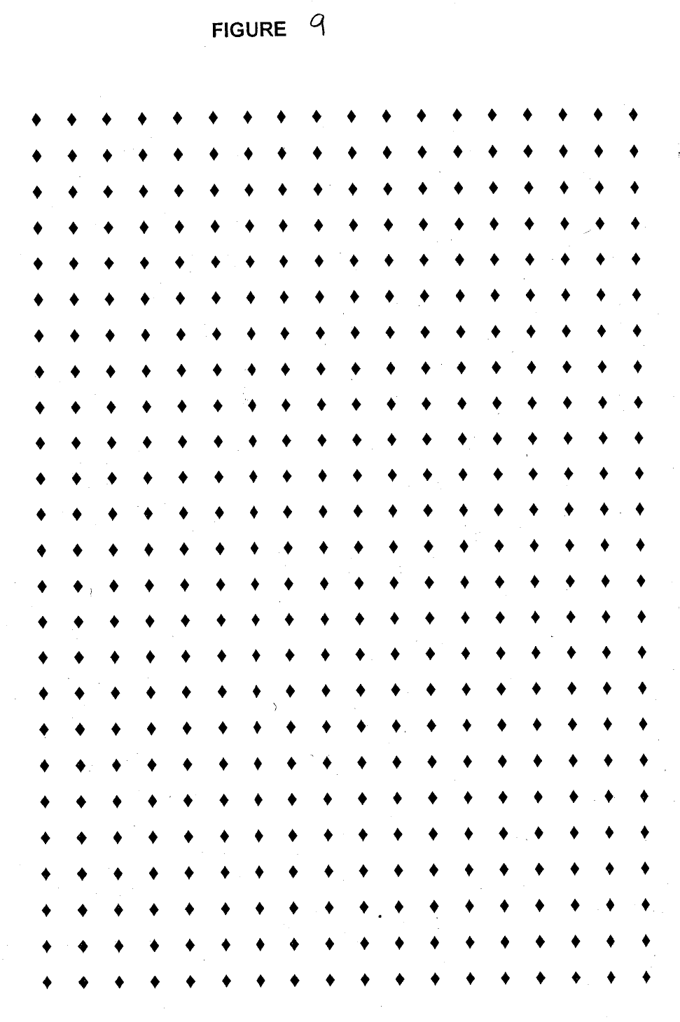

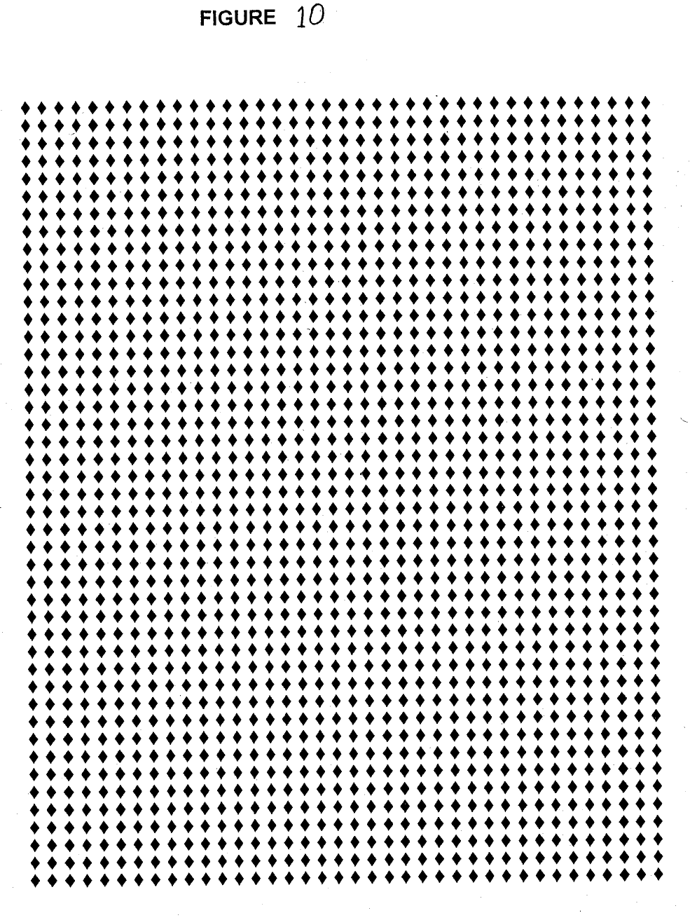

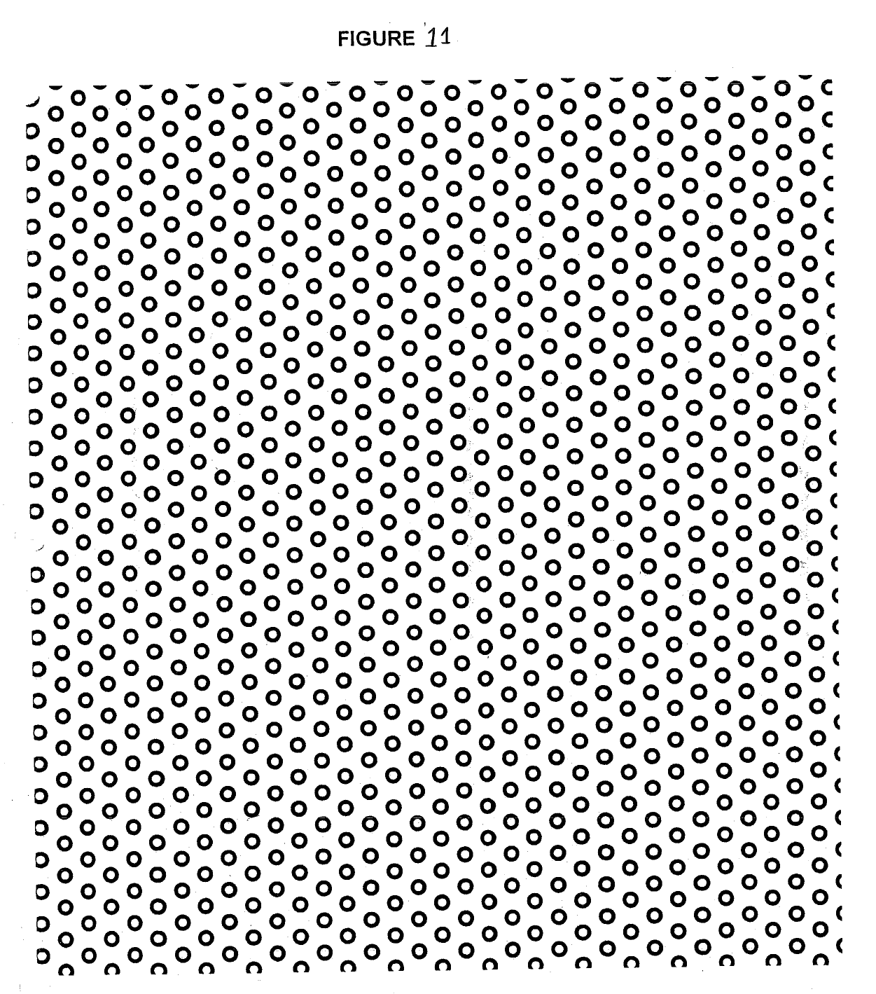

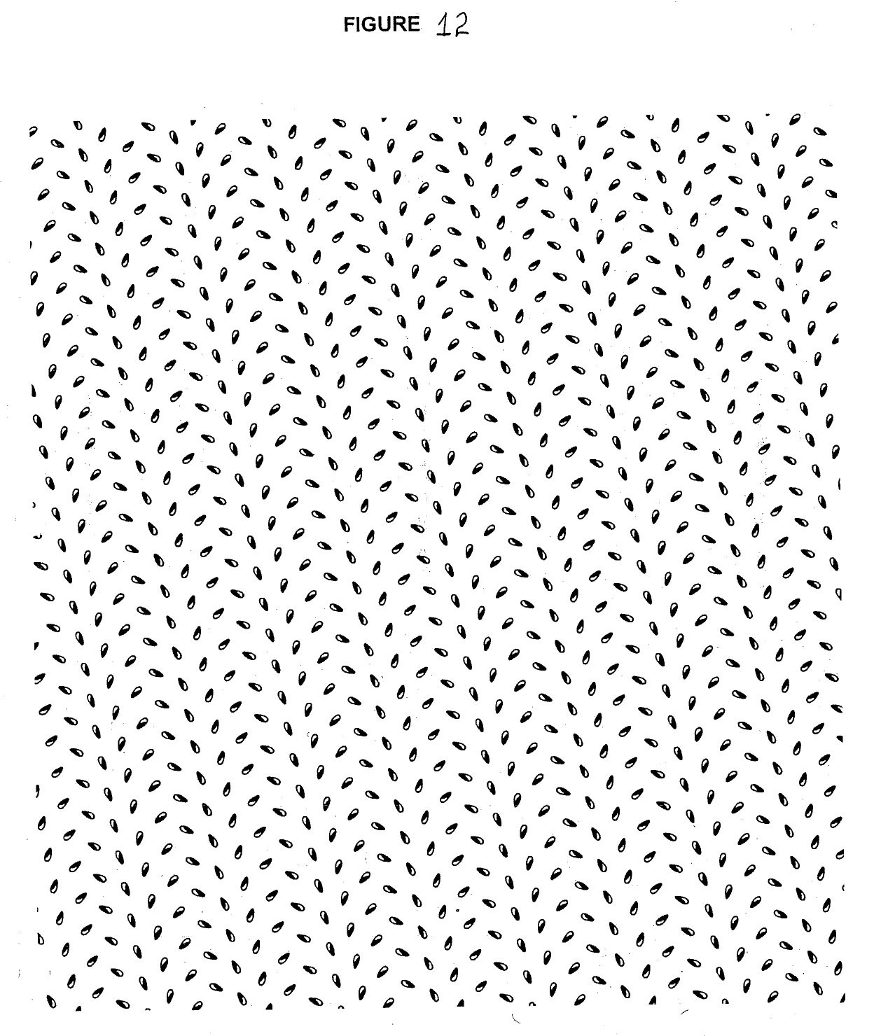

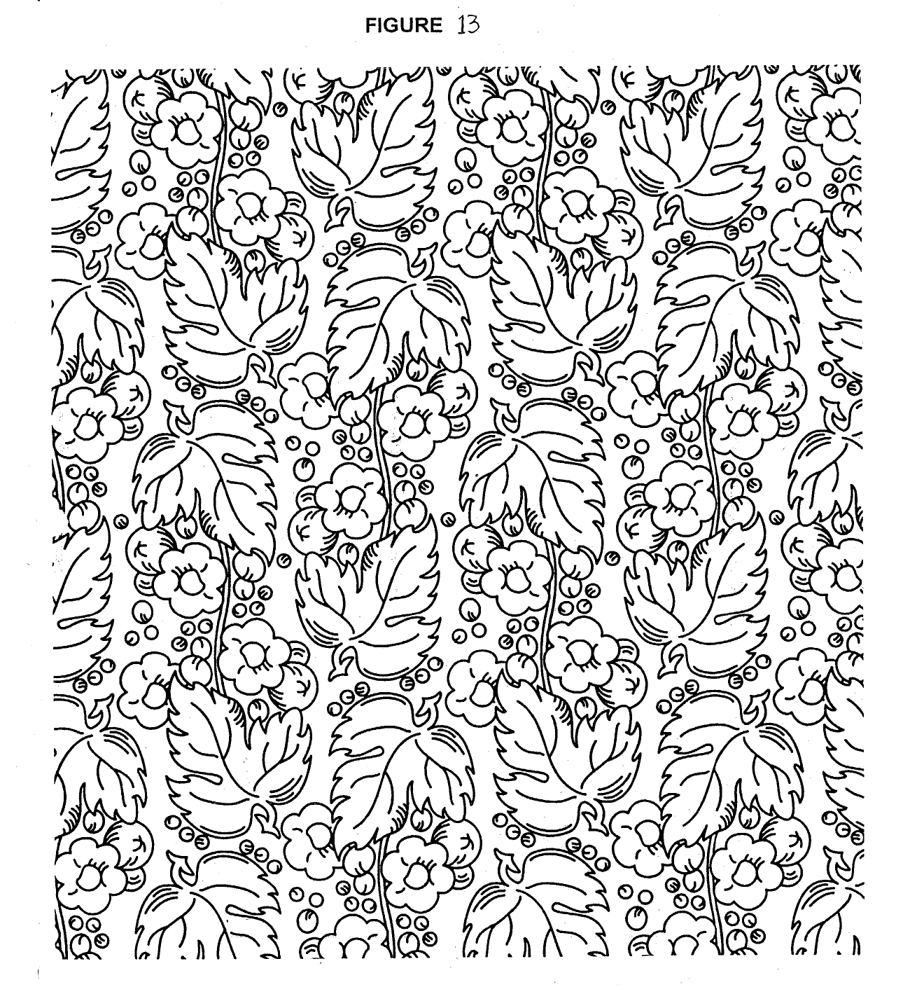

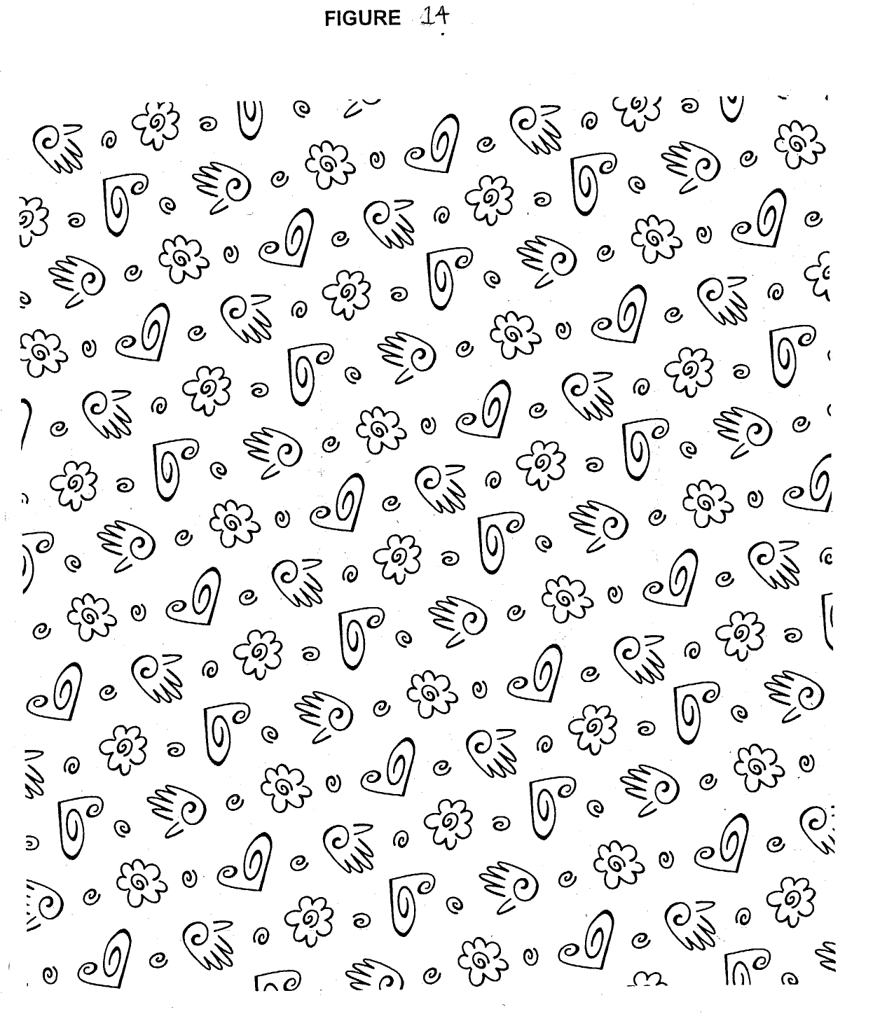

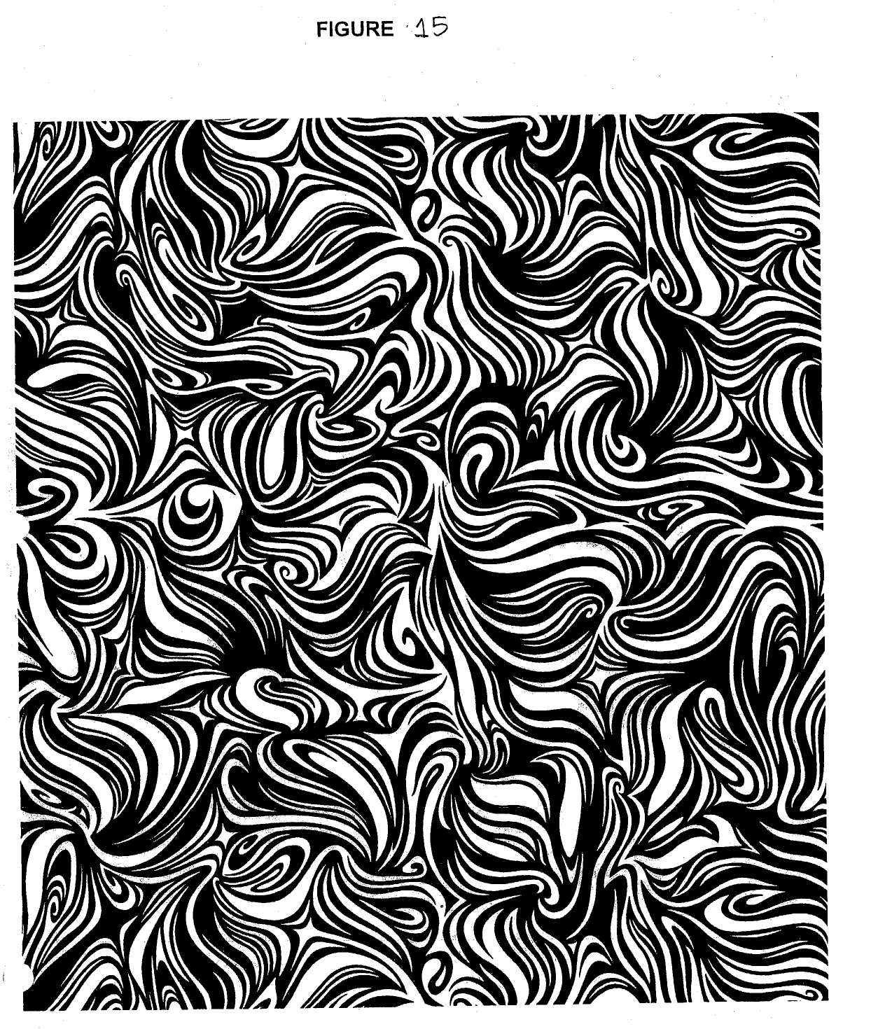

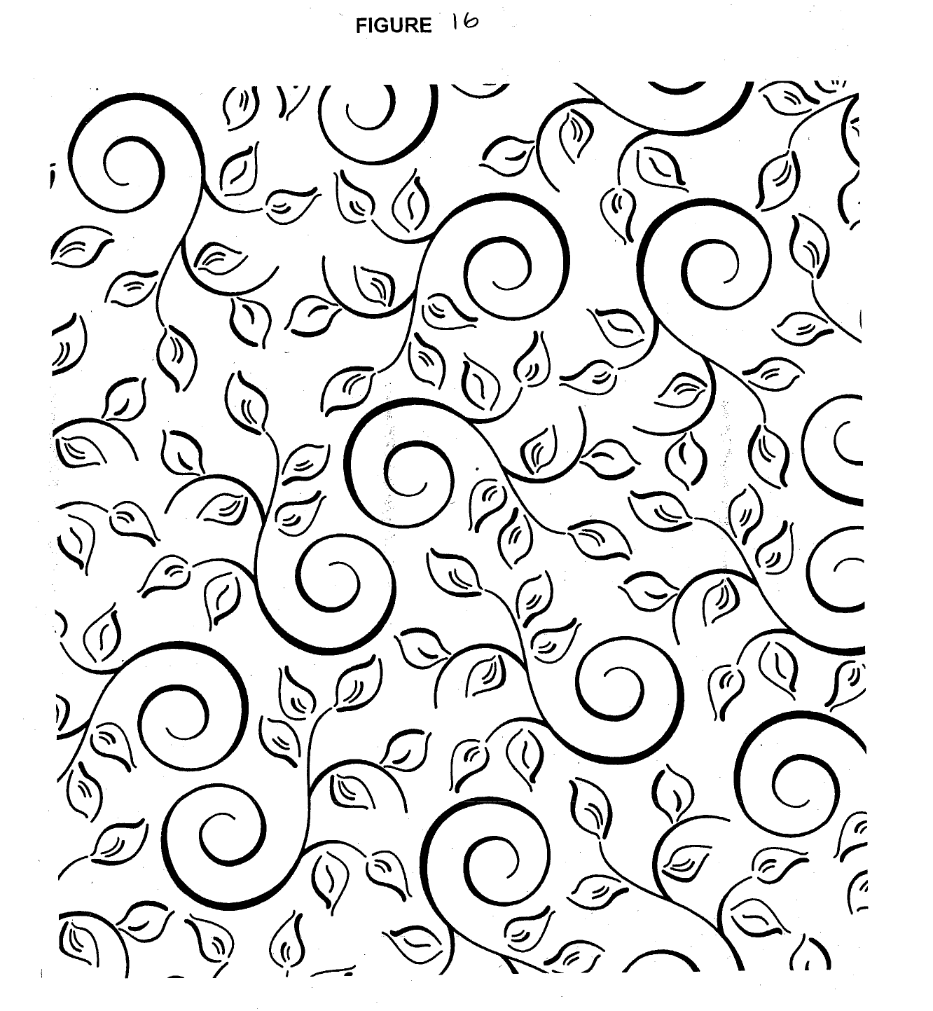

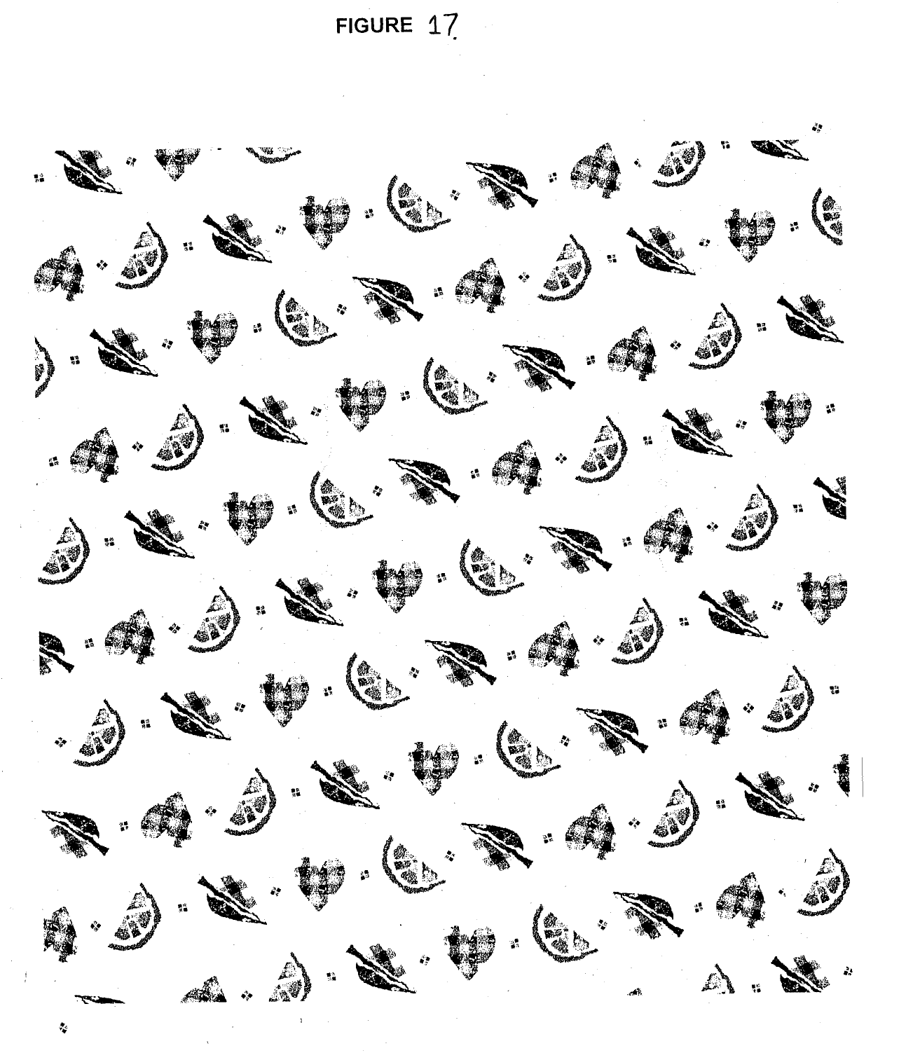

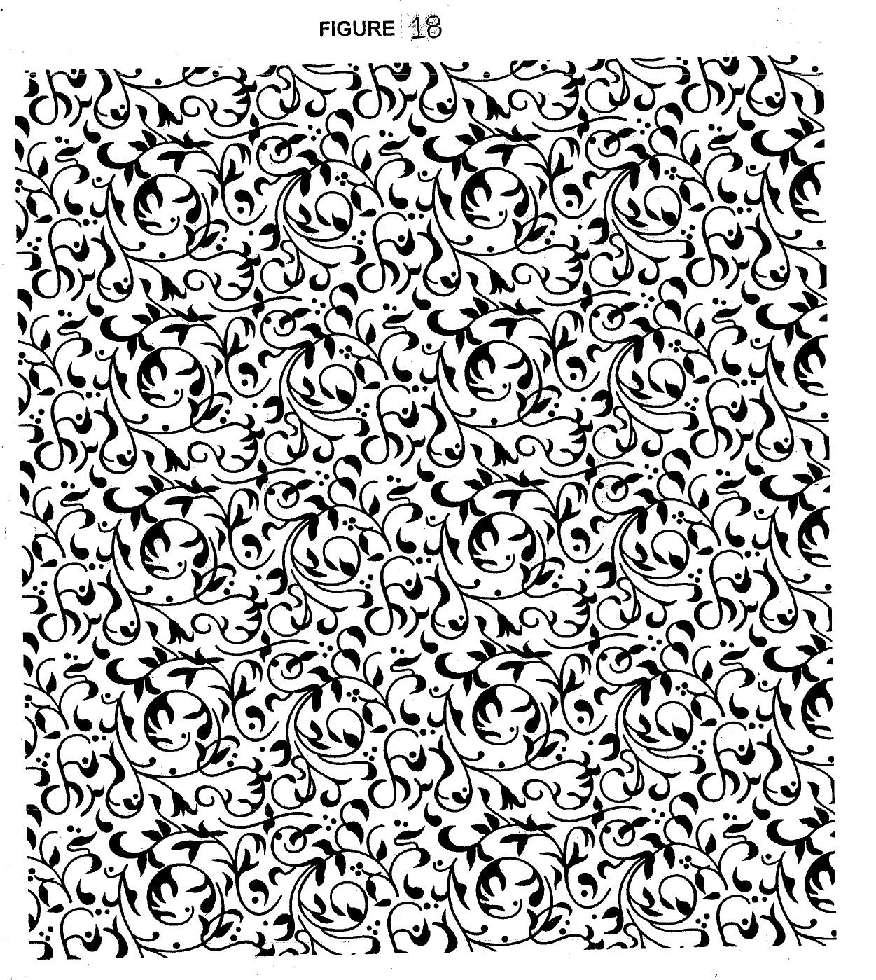

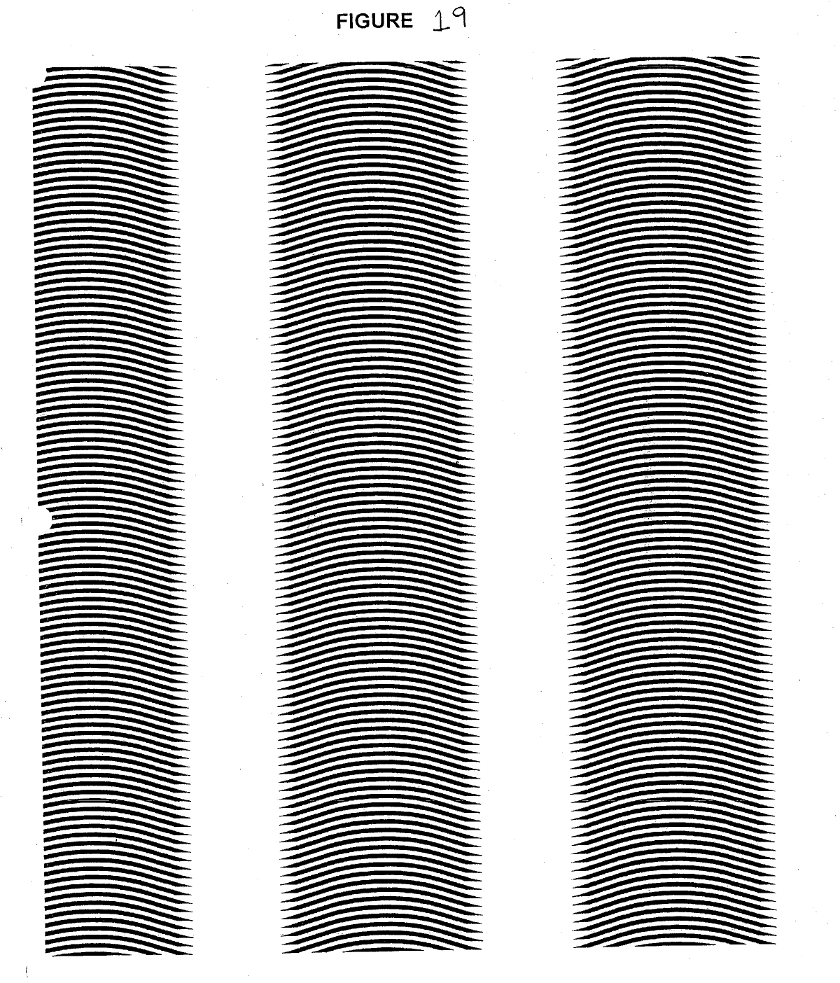

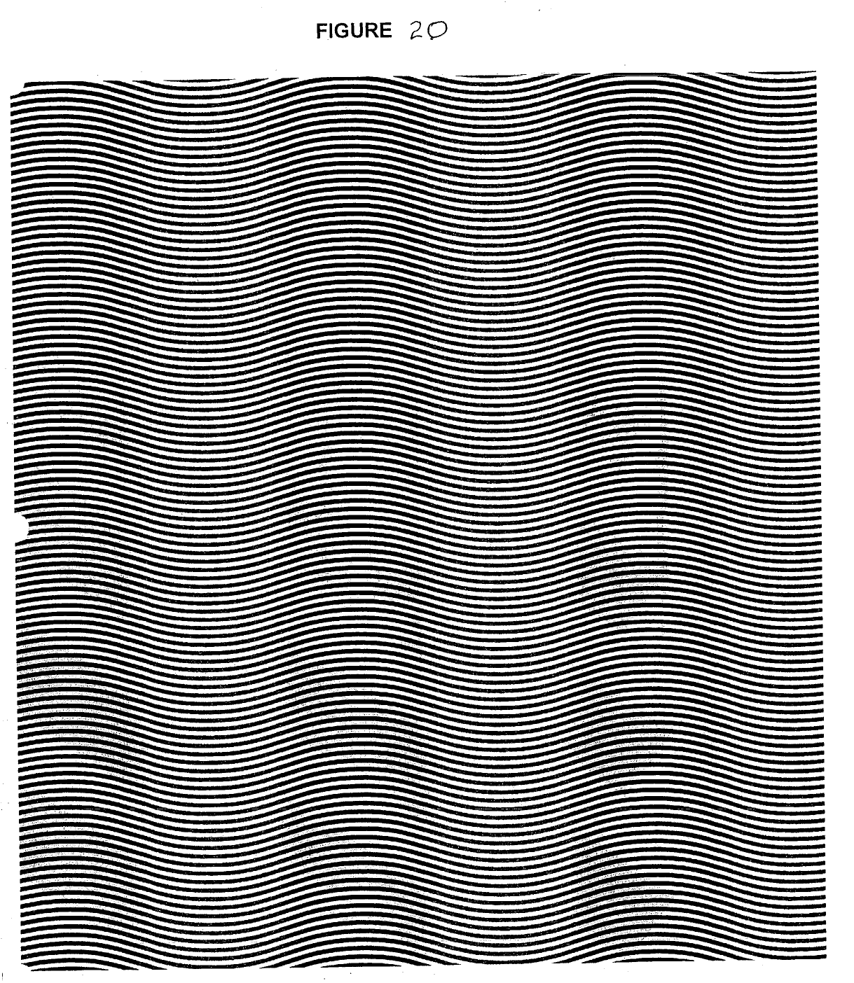

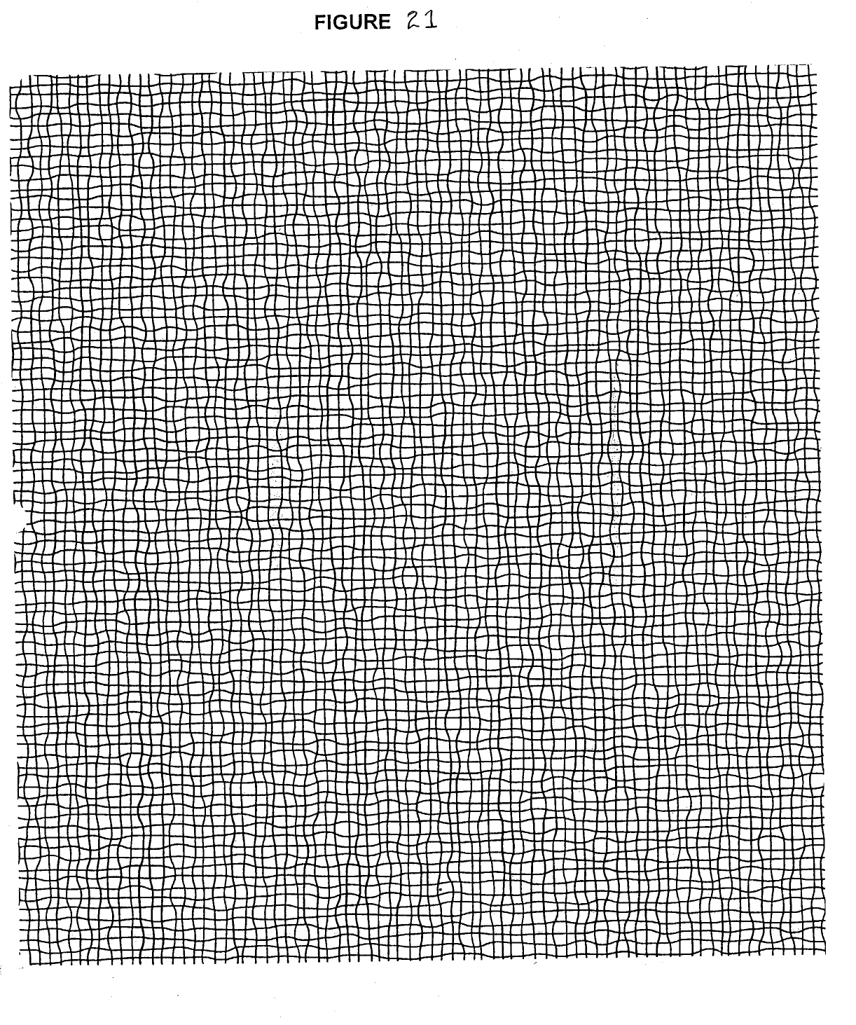

TABLE 1
2^{ND}-Order Polynomial of % Area vs.
Dilation Step from Various Patterns

| Sample Pattern | Coeff OF X\hat{ }2 | Coeff of X | Y-Intercept |
|---|---|---|---|
| Burst 1 (FIG. 1) | −0.53 | 14.2 | 4.02 |
| Burst 1, 20-degree rotation | −0.50 | 13.8 | 4.12 |
| Burst 1, 40-degree rotation | −0.46 | 13.5 | 3.14 |
| Burst 2 (FIG. 4) | −0.66 | 14.9 | 3.60 |
| Burst 2, No JoinDots (FIG. 5) | −0.61 | 14.3 | 3.00 |
| Burst 2, No CenterDots | −0.62 | 14.6 | 3.05 |
| (FIG. 6) | | | |
| Interconnected Circles | −0.35 | 8.99 | 34.7 |
| (FIG. 7) | | | |
| Dots (FIG. 8) | 0.33 | 1.73 | 1.56 |
| Diamonds1 (FIG. 9) | 0.29 | 2.91 | 4.33 |
| Diamonds2 (FIG. 10) | −0.13 | 16.8 | 17.7 |
| Bubble (FIG. 11) | −0.71 | 15.8 | 17.4 |
| Citrus (FIG. 12) | 0.049 | 9.0 | 6.7 |
| Deco (FIG. 13) | −0.94 | 16.7 | 24.5 |
| Family (FIG. 14) | −0.28 | 9.1 | 12.9 |
| Feather (FIG. 15) | −1.77 | 16.8 | 60.3 |
| Leaves (FIG. 6) | −0.35 | 10.1 | 13.2 |
| Spring (FIG. 17) | −0.12 | 5.7 | 13.4 |
| Vines (FIG. 18) | −1.4 | 19.7 | 30.7 |
| Wave1 (FIG. 19) | −0.63 | 9.2 | 34.0 |
| Wave2 (FIG. 20) | −2.7 | 29.8 | 50.4 |
| Woven (FIG. 21) | −4.6 | 34.2 | 35.4 |

From the above results, it can be seen that the patterns made according to the present invention are distinct and can be distinguished from other patterns based upon the output polynomial.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A nonwoven product comprising:
a base sheet comprising a nonwoven web; and
a patterned indicia indicating the presence of an additive that has been applied to the base sheet, the patterned indicia being visible from at least one side of the base sheet, the patterned indicia having a burst-like design that, when comparing percent area coverage of the indicia versus dilation, the patterned indicia is defined by the following mathematical expression:
f(x)=Ax²+Bx+Y
wherein A is from about −0.7 to about −0.4; B is from about 12 to about 16; and Y is from about 2 to about 5.

2. A nonwoven product as defined in claim 1, wherein the product comprises a tissue product.

3. A nonwoven product as defined in claim 1, wherein the nonwoven web comprises polymeric fibers.

4. A nonwoven product as defined in claim 3, wherein the nonwoven web comprises a spunbond web or a meltblown web.

5. A nonwoven product as defined in claim 1, wherein the nonwoven web comprises pulp fibers.

6. A nonwoven product as defined in claim 1, wherein the base sheet contains multiple plies.

7. A nonwoven product as defined in claim 6, wherein the base sheet includes internal ply surfaces, the patterned indicia being applied to at least one of the internal ply surfaces.

8. A nonwoven product as defined in claim 1, wherein the patterned indicia comprises a printed pattern.

9. A nonwoven product as defined in claim 1, wherein the base sheet is white and the patterned indicia is blue.

10. A nonwoven product as defined in claim 1, wherein the base sheet is white and the patterned indicia is green.

11. A nonwoven product as defined in claim 1, wherein the additive comprises a virucide.

12. A nonwoven product as defined in claim 1, wherein the additive comprises a softener.

13. A nonwoven product as defined in claim 12, wherein the softener comprises a polysiloxane.

14. A nonwoven product as defined in claim 1, wherein the additive comprises an emollient, an encapsulated scent, a cleansing agent, a moisturizer, an antimicrobial agent, or an antiseptic.

15. A nonwoven product as defined in claim 1, wherein the base sheet has a basis weight of from about 10 gsm to about 100 gsm.

16. A tissue product comprising two or more plies and thereby having two or more internal ply surfaces, two of the plies being outer plies, wherein one or more of the internal surfaces contains a patterned indicia which is visible through at least one of the outer plies, the patterned indicia having a burst-like design that, when comparing percent area coverage of the indicia versus dilation, the patterned indicia is defined by the following mathematical expression:
f(x)=Ax²+Bx+Y
wherein A is from about −0.7 to about −0.4; B is from about 12 to about 16; and Y is from about 2 to about 5.

17. A tissue product as defined in claim 16, wherein the tissue product is a two-ply product.

18. A tissue product as defined in claim 16, wherein the patterned indicia comprises a printed pattern.

19. A tissue product as defined in claim 16, wherein the tissue product comprises two outer plies and a center ply, the patterned indicia being applied to the center ply.

20. A tissue product as defined in claim 16, wherein the tissue product contains a virucide.

21. A tissue product as defined in claim 16, wherein the tissue product contains a softener, an emollient, an encapsulated scent, a cleansing agent, a moisturizer, an antimicrobial agent, or an antiseptic.

22. A tissue product as defined in claim 16, wherein the patterned indicia is blue in color.

23. A tissue product as defined in claim 22, wherein the plies have a white color.

24. A nonwoven product comprising:
a base sheet comprising a nonwoven web;
a patterned indicia indicating the presence of an additive that has been applied to the base sheet, the additive comprising a virucide, a softening agent, an emollient, an encapsulated scent, a cleansing agent, a moisturizer, a antimicrobial agent, or an antiseptic, the patterned indicia being visible from at least one side of the base sheet, the patterned indicia having a blue color and having a burst-like design that when comparing percent area coverage of the indicia versus dilation, the patterned indicia is defined by the following mathematical expression:
f(x)=Ax²+Bx+Y
wherein A is from about −0.7 to about −0.4; B is from about 12 to about 16; and Y is from about 2 to about 5.

25. A nonwoven product as defined in claim 24, wherein the nonwoven product comprises a tissue product having multiple plies defining internal ply surfaces, the patterned indicia being applied to at least one of the internal ply surfaces.

26. A nonwoven product as defined in claim 25, wherein the product comprises a facial tissue or bath tissue and wherein the base sheet has a basis weight of from about 10 gsm to about 45 gsm.

27. A nonwoven product as defined in claim 24, wherein the product comprises a wet wipe, the nonwoven web comprising a coform web comprising pulp and polymeric fibers.

28. A nonwoven product as defined in claim 24, wherein the patterned indicia comprises a printed pattern.

29. A nonwoven product as defined in claim 24, wherein the nonwoven web comprises a meltblown web.

30. A nonwoven product as defined in claim 24, wherein the nonwoven web comprises a spunbond web.

31. A nonwoven product as defined in claim 24, wherein the base sheet comprises a spunbond-meltblown-spunbond laminate.

32. A nonwoven product as defined in claim 24, wherein the nonwoven web of the base sheet comprises pulp fibers, the nonwoven product comprising a paper towel.

33. A nonwoven product as defined in claim 24, wherein the base sheet has a single ply.

34. A nonwoven product as defined in claim 24, wherein the patterned indicia only covers a portion of a surface contained in the base sheet.
